(19) United States
(12) Patent Application Publication
(10) Pub. No.: US 2006/0145444 A1
(43) Pub. Date: Jul. 6, 2006

(54) Skateboard hockey

(76) Inventor: Norman Garland, Willowick, OH (US)

Correspondence Address: LINDON & LINDON, 1250 LINDA STREET, ROCKY RIVER, OH, 44116, US

(21) Appl. No.: 11/028,092

(22) Filed: Jan. 3, 2005

(51) Int. Cl. B62M 1/00

(52) U.S. Cl. 280/87.042

(57) ABSTRACT

A device operatively connected to a skateboard. The device is moveable and adapted for contact of a puck.

### BACKGROUND OF THE INVENTION

This invention relates in general to a device for use in playing skateboard hockey. Skateboards are popular among sports enthusiast, as is the sport of hockey. It would thus be desirable to produce a device for combining both skateboarding and hockey.

### SUMMARY OF THE INVENTION

The above advantages as well as other advantages not specifically enumerated are achieved by a device operatively connected to a skateboard. The device is moveable and adapted for contact of a puck. There is also provided a device for playing a hockey game. The device includes a skateboard and a moveable blade operatively connected the skateboard. There is also provided a method of playing skateboard hockey. The method includes providing a skateboard having a blade operatively connected to the skateboard. The method also includes providing a puck to be contacted with the blade.

This invention relates generally to a device for use in playing skateboard hockey. The device offers the advantage of providing a striker or blade operatively connected to a skateboard. The device offers the advantage of providing a hand control means for positioning the striker or blade. Other advantages of this invention will become apparent to those skilled in the art from the following detailed description of the preferred embodiments, when read in light of the accompanying drawings.

### BRIEF DESCRIPTION OF THE DRAWINGS

FIG. 1 is a plan view from underneath of a skateboard assembly according to a first embodiment of the present invention.

FIG. 2 is a perspective view from underneath of a skateboard employing the skateboard assembly of FIG. 1.

FIG. 3 is a perspective side and frontal view of a skateboard employing the skateboard assembly of FIG. 1.

FIG. 4 is a frontal view of a skateboard employing the skateboard assembly of FIG. 1.

FIG. 5 is an ice-blade usable with the skateboard assembly of FIG. 1.

FIG. 6 is a simplified plan view of the blade employed with the skateboard assembly of FIG. 1 in a first (forward-directed) extended position.

FIG. 7 is a simplified plan view of the blade employed with the skateboard assembly of FIG. 1 in a second (right-directed) extended position.

FIG. 8 is a simplified plan view of the blade employed with the skateboard assembly of FIG. 1 in a third (left-directed) extended position.

FIG. 9 is a plan view of a hand control usable with the skateboard assembly of FIG. 1.

### DETAILED DESCRIPTION OF THE PREFERRED EMBODIMENTS

This application claims the benefit of U.S. Provisional Application No. 60/533,998, filed Jan. 5, 2004.

Preliminarily, it should be noted that certain terms used herein, such as “front”, “back”, “bottom”, “top”, “left”, “right”, “upper”, and “lower” are used to facilitate the description of the preferred embodiment of the invention. Such terms are not intended as a limitation on the position in which the components of the invention may be used. Likewise, numerical terms used herein, such as “first”, and “second” are used to facilitate the description of the preferred embodiment of the invention and do not impose a sequential limitation unless otherwise indicated by the context.

Referring now to the drawings, there is illustrated a skateboard assembly, indicated generally at 10, and a hand control, indicated generally at 15, in accordance with the present invention. It will be noted that the skateboard assembly 10 is secured to a bottom surface 20 of a skateboard 25. The illustrated skateboard assembly 10 is secured at a front portion 30 of the skateboard 25, though may be secured to any suitable portion of the skateboard 25. The illustrated front portion 30 of the skateboard 25 is generally rounded. A puck 35 is also employed. The puck 35 may be a prior art puck or may be adapted to use.

The illustrated skateboard assembly 10 includes a front truck assembly 40 and a rear truck assembly 45. The illustrated front truck assembly 40 includes a bracket 50, a first front wheel 55, a second front wheel 60 and an axel assembly 65. The bracket 50 is secured to the bottom surface 20 of the skateboard 25.

The illustrated skateboard assembly 10 includes a blade 70. The illustrated blade 70 is a generally straight rigid member. The blade 70 may be a generally flat plate and may be made with any suitable material and be adapted to any suitable shape. The blade 70 is a striking means.

FIG. 5 illustrates a generally curved ice-blade 71 which may also be employed instead of or in conjunction with the wheels 55, 60. It will be noted that the rear truck assembly 45 also includes two wheels which are substantially similar to the wheels 55, 60 of the front truck assembly 40. The ice-blade 71 may also be employed with the rear truck assembly 45. Any suitable number and positioning of the ice-blade(s) 71 on the skateboard 25 may be used. It should also be understood that the term “ice-blade” should not be understood as a limitation on the materials or use for the ice-blade 71. Indeed, the ice-blade 71 may be employed on any suitable, preferably smooth surface on which the skateboard assembly 10 may be used. It should be noted that the ends of ice-blade 71 are curved generally upwardly as shown to allow the ends of the ice-blade 71 to be secured to or positioned close to the bottom surface 20 of the skateboard 25.

The blade 70 may be secured to a mounting bracket 75. One or both of the blade 70 and the mounting bracket 75 may be secured to a bearing 80. The bearing 80 facilitates a pivoting movement of the blade 70, as generally indicated by the arrow 81 and arrow 82. The illustrated bearing 80 is positioned within a “C” channel 90. The “C” channel 90 may be provided in a platform 95. The platform 95 may be secured to the bottom surface 20 of the skateboard 25 and may be positioned between the bracket 50 and the skateboard 25.

The illustrated skateboard assembly 10 also includes two solenoids 100a, 100b. The term “solenoid” is understood to include a coil, which may be in cylindrical form. When the solenoids are carrying a current, the solenoids act like a magnet so that a movable core is drawn into the coil when a current flows. The solenoids 100a, 100b are used as a control for the blade 70. The solenoids 100a, 100b are mechanical devices for moving or controlling the position of the blade 70.

The illustrated solenoids 100a, 100b are operatively connected to a power source 105 within a compartment 110 provided. The compartment 110 may be provided in the bottom surface 20 of the skateboard 25 or any other suitable location. The illustrated power source 105 is six 9-volt batteries, though any suitable power source may be used. The power source 105 is provided to activate the solenoids 100a, 100b.

Each of the solenoids 100a, 100b may be secured to a pivot bracket 115a, 115b. The illustrated pivot brackets 115a, 115b are positioned between the blade 70 and the solenoids 100a, 100b. The pivot brackets 115a, 115b are secured to the mounting bracket 75 of the skateboard assembly 10.

The hand control 15 may be operatively connected to the skateboard assembly 10 by a wire 120. The hand control 15 may be operatively connected to the skateboard assembly 10 by a wireless means or any other suitable means. When the wire 120 is employed, a quick connector 125 may be used to allow for a relatively quicker disconnection between the hand control 15 and the skateboard assembly 10. The hand control 15 is a control means for the skateboard assembly 10.

The illustrated hand control 15 is a generally hand-shaped device and may employ a glove. The illustrated hand control 15 also includes a ground 130 on a thumb portion 135 of the hand control 15. The term “ground” is understood to include a conductive connection through which electrical current passes to complete a circuit.

The illustrated hand control 15 also includes a first sensor 140 on an index finger portion 145 of the hand control 15. The illustrated hand control 15 also includes a second sensor 150 on a middle finger portion 155 of the hand control 15. The first sensor 140 and the second sensor 150 may be positioned at any suitable location of the hand control 15. The term “sensor” is understood to include any device that responds to a physical stimulus (as heat, light, sound, pressure, magnetism, or a particular motion) and transmits a resulting impulse or outcome (as for measurement or operating a control).

The first sensor 140 may be operatively connected to either or both of the solenoids 100a, 100b. The second sensor 150 may be operatively connected to either or both of the solenoids 100a, 100b. The ground 130 maybe operatively connected to either or both of the solenoids 100a, 100b.

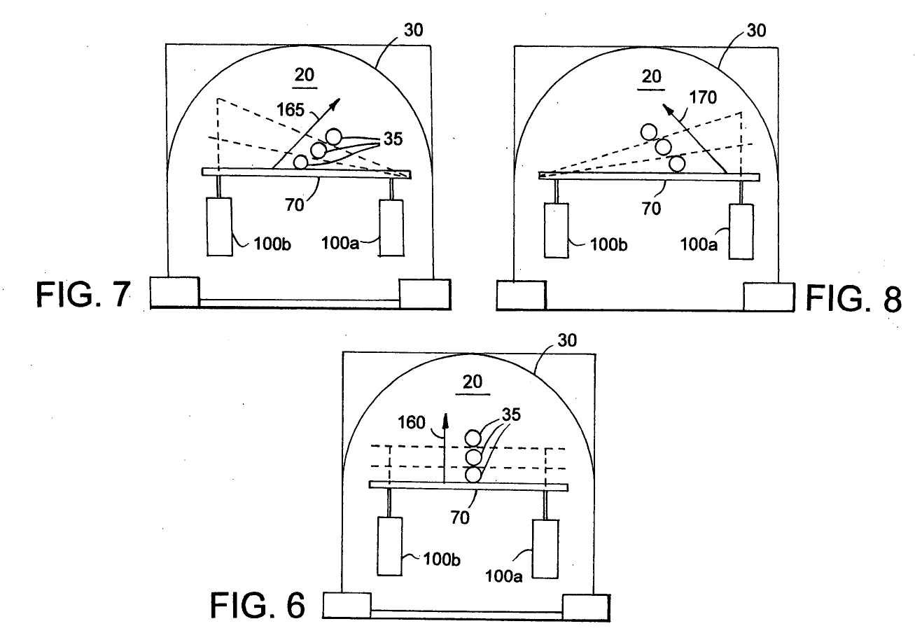

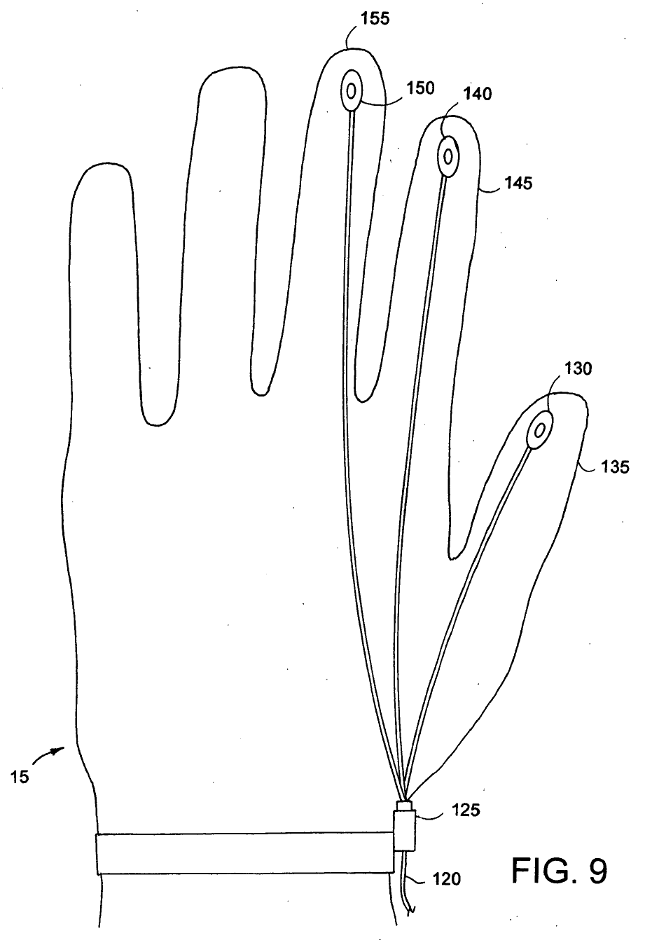

FIGS. 6, 7, and 8 show the blade 70 of the skateboard assembly 10 in various positions or states of motion in cooperation with the hand control 15 and the solenoids. 100a, 100b. FIG. 6 shows what happens when the first sensor 140 and the second sensor 150 are contacted about simultaneously to the ground 130. Specifically, the portion of the blade 70 operatively connected to the solenoid 100a moves about the same amount as the portion of the blade 70 operatively connected to the solenoid 100b moves. That is, both solenoids 100a, 100b extend so as to move the blade 70 forward. It will be appreciated that, if the puck 35 were positioned generally in front and within the path of motion of the blade 70, the puck 35 would move generally straight ahead, as indicated by the directional arrow 160.

FIG. 7 shows what happens when the first sensor 140 is contacted to the ground 130, the first sensor 140 being operatively connected to the solenoid 100b so as to move the solenoid 100b outwardly relative to the solenoid 100a. It will be appreciated that, if the puck 35 were positioned in front and within the path of motion of the blade 70, the puck 35 would move generally to the right and ahead, as indicated by the directional arrow 165.

FIG. 8 shows what happens when the second sensor 150 is contacted to the ground 130, the second sensor 150 being operatively connected to the solenoid 100a so as to move the solenoid 100a outwardly relative to the solenoid 100b. It will be appreciated that, if the puck 35 were positioned in front and within the path of motion of the blade 70, the puck 35 would move generally to the left and ahead, as indicated by the directional arrow 175.

It will be appreciate that the invention is useful for directing a puck 35 and for allowing a human user (not shown) to use the invention to play a type of skateboard hockey. The following U.S. Patents or publications are attached herewith and hereby incorporated by reference herein as if fully rewritten;
U.S. Pat. No. 1,672,700 to Vass (1925)
U.S. Pat. No. 2,220,291 to Savoy (1940)
U.S. Pat. No. 2,269,357 to Dent (1942)
U.S. Pat. No. 3,044,566 to G. Mayr (1962)
U.S. Pat. No. 3,437,161 to D. E. Ufford (1967)
U.S. Pat. No. 3,876,032 to Ferino (1975)
U.S. Pat. No. 4,073,356 to Schlicht (1978)
U.S. Pat. No. 4,143,728 to Shiber (1979)
U.S. Pat. No. 4,151,892 to Francken (1979)
U.S. Pat. No. 4,600,073 to Honett (1986)
U.S. Pat. No. 2,782,531 to Frazier et al. (1957)
U.S. Pat. No. 3,256,873 to R. A. George (1966)
U.S. Pat. No. 3,990,713 to Hokanson (1976)
U.S. Pat. No. 4,140,326 to Huber (1979)
U.S. Pat. No. 4,194,753 to Schrishuhn, Jr. (1980)
U.S. Pat. No. 4,805,934 to Mullenax (1989)
U.S. Pat. No. 5,004,256 to Won (1991)
U.S. Pat. No. 5,255,917 to Morrow et al. (1993)
U.S. Ser. No. 2002/0043777 A1 to Ireton (2002)

Alternate embodiments may be considered. The solenoids may be spring-loaded for enhanced puck speed and responsiveness. A spring or other resilient means may be employed in any suitable fashion. Increased or enhanced stored energy or potential energy for movement of the blade 70 may produce a comparatively faster game of skateboard hockey.

Operation of the hand control 15 may be adapted to accommodate operation of a resilient-loaded embodiment. By way of illustration, the longer the user makes contact between the ground 130 on a thumb portion 135 of the hand control 15 and the first sensor 140 on the index finger portion 145 of the hand control 15, the more the spring or other resilient means might compress. Analogous contact with the second sensor 150 or other appropriate sensor might be considered. The more compression, the more potential for blade speed and/or puck speed which may result when the contact ends.

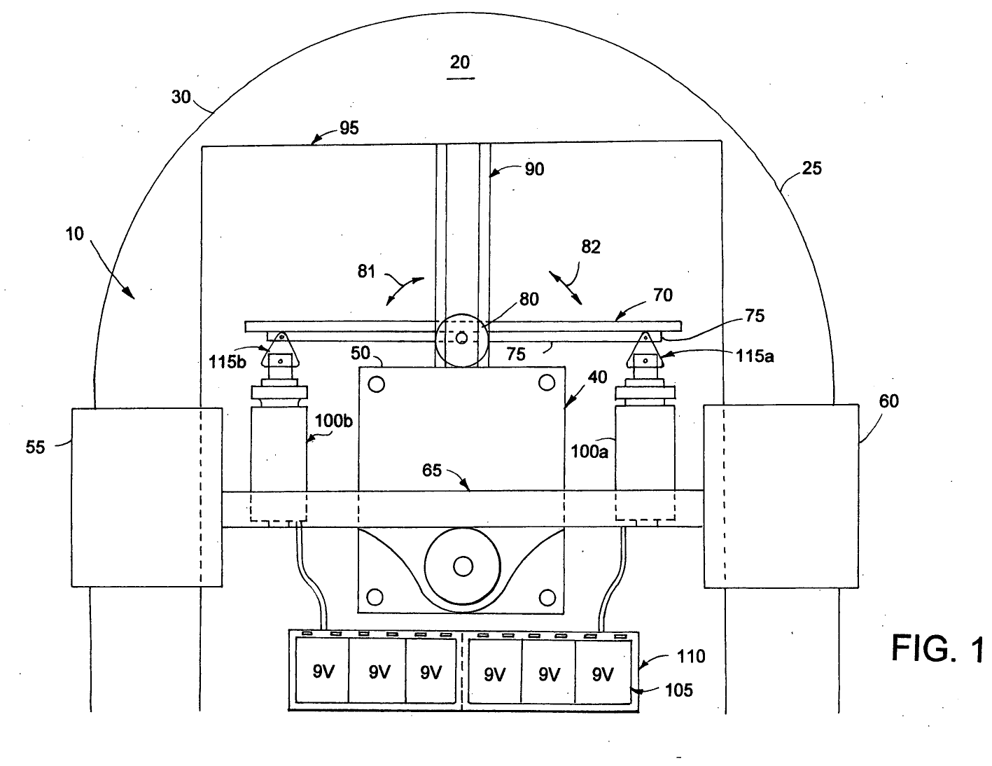

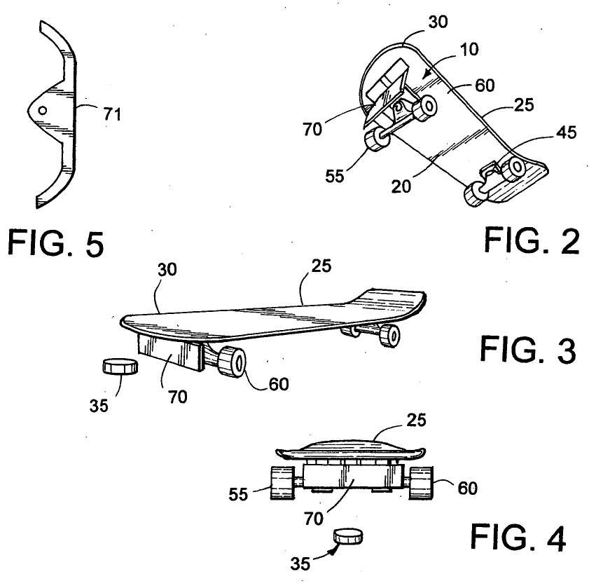

The bearing 80 may be adjusted and/or made adjustable as desired. Wheels on skateboards, such as for example the wheels 55, 60 of the front truck assembly 40, may wear with use. As the wheels wear, the skateboard 25 and/or the blade 70 might become closer to the ground or the surface on which the user is skating. A mid-portion of the illustrated generally circular bearing 80 (shown in FIG. 1) features an adjustment means. The adjustment means may be manipulated, such as for example tightened and/or loosened to raise or lower the blade 70 and/or the front truck assembly 40 or portions thereof. The illustrated blade 70 may thus be adjustable along a generally vertical axis.

What is claimed is:

1. A device operatively connected to a skateboard, said device being moveable and adapted for contact of a puck.

2. The device of claim 1, further comprising a control means wherein the device is operatively connected to the control means.

3. The device of claim 2 wherein the control means is a hand control.

4. The device of claim 1 wherein the device is a generally flat plate.

5. The device of claim 1 wherein the device is adapted for pivotal movement.

6. The device of claim 1 wherein the device is operatively connected to a solenoid.

7. The device of claim 1 wherein the device is adjustable along a generally vertical axis.

8. The device of claim 1 wherein the device is operatively connected to a resilient means.

9. The device of claim 1 further comprising a hand control with a sensor on a finger portion of the hand control, wherein the hand control is operatively connected to the device.

10. The device of claim 1 further comprising a conductive connection on a finger.

11. A device for playing a hockey game comprising:
a skateboard;
a moveable blade operatively connected the skateboard.

12. The device of claim 11 wherein the blade is pivotally mounted.

13. The device of claim 11 wherein the blade is operatively connected to a solenoid.

14. The device of claim 11 wherein the blade is adjustable along a generally vertical axis.

15. The device of claim 11 further comprising a hand control to move the blade.

16. A method for playing skateboard hockey comprising: providing a skateboard having a blade operatively connected to the skateboard; providing a puck to be contacted with the blade.

17. The method of claim 16 wherein the blade is pivotally mounted to the skateboard.

18. The method of claim 16 wherein the blade is operatively connected to a solenoid.

19. The method of claim 16 further comprising a hand control with a sensor on a finger portion of the hand control, wherein the hand control is operatively connected to the blade.

20. The method of claim 16 wherein the blade is adapted for pivotal movement.
